(19) United States
(12) Patent Application Publication
(10) Pub. No.: US 2015/0234859 A1
(43) Pub. Date: Aug. 20, 2015

(54) Managing Inferred Data

(71) Applicants: David Calvin JOHNSON, Katy, TX (US); LANDMARK GRAPHICS CORPORATION, Houston, TX (US)

(72) Inventor: David Calvin Johnson, Katy, TX (US)

(73) Assignee: Landmark Graphics Corporation, Houston, TX (US)

(21) Appl. No.: 14/434,704

(22) PCT Filed: Oct. 30, 2012
(86) PCT No.: PCT/US2012/062543

§ 371 Date: Apr. 9, 2015

(51) Int. Cl. G06F 17/30

(52) U.S. Cl. CPC G06F 17/30176; G06F 17/30864

(57) ABSTRACT

A relationship between entity 1 data stored in a first system regarding an entity 1, and entity 2 data stored in a second system, different from the first system, regarding an entity 2 is stored in a relationship database. A relationship between the entity 1 data stored in the first system and entity 3 data stored in a third system, different from the first system and the second system, regarding an entity 3 is stored in the relationship database. A relationship between the entity 2 data and the entity 3 data is inferred by analyzing the relationship between the entity 1 data and the entity 2 data stored in the relationship database, and the relationship between the entity 1 data and the entity 3 data stored in the relationship database. The inferred relationship between the entity 2 data and the entity 3 data is stored in the relationship database.

### BACKGROUND

Data regarding assets, such as oil wells, may be stored in more than one database. The identifier, such as a name, of an asset in one database may be different from the name of the same asset in another database. Data about an asset may be moved from one or more databases and stored in another database. Synchronizing such data can be a challenge.

### BRIEF DESCRIPTION OF THE DRAWINGS

FIG. 1 shows the storage of information about an asset in various database systems.

FIGS. 2-6 show the generation of data in a relationship database.

FIG. 7 shows applications that have use of the relationship database.

FIG. 8 shows details of the relationship database.

FIG. 9 is a flow chart.

FIG. 10 shows a computer environment.

### DETAILED DESCRIPTION

While this specification is written about synchronization of data about hydrocarbon wells, the techniques described herein would apply to any asset. In particular, the techniques described herein would apply to any process where data from multiple sources is used in a merged fashion. In one example, data from sources 1 and 2 are used and then data from sources 2 and 3 are used. From these uses, a relationship between sources 1 and 3, that was not originally required but can be taken advantage of in other processes, is inferred.

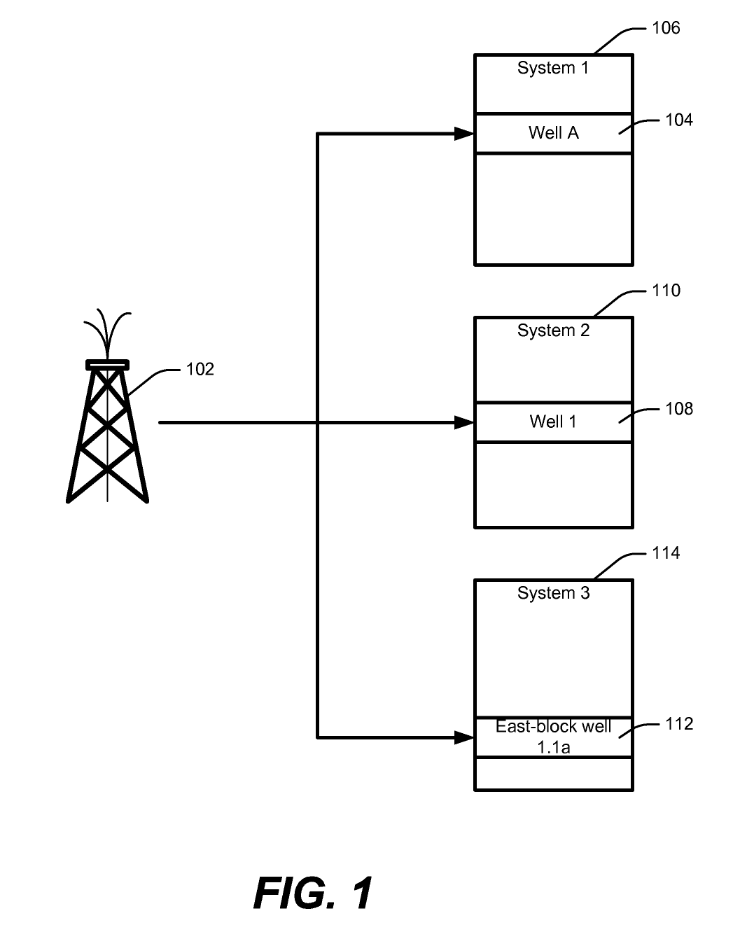

Turning to FIG. 1, data-1 104 concerning an oil well 102 is stored in database-system-1 106, where oil well 102 is referred to as “Well A.” Data-2 108 concerning the oil well 102 is stored in database-system-2 110, where oil well 102 is referred to as “Well 1.” Data-3 112 concerning the oil well 102 is stored in database-system-3 114, where oil well 102 is referred to as “East-block well 1.1a.” Data-1 104, data-2 108, and data-3 112 may be completely different data, they may be the same data, or they may have some data that is the same and other data that is different.

In one embodiment, database-system-1 106, database-system-2 110, and database-system-3 have no technical relationship; that is they have no shared code or database structures.

In one embodiment, each of the data-1 104 stored in database-system-1 106, the data-2 108 stored in database-system-2 110, and the data-3 112 stored in database-system-3 114 supports a respective, and possibly completely different, set of business processes and applications and is updated as necessary to support those business processes and applications.

A user reviewing database-system-1 106, database-system-2 110, and database-system-3 114 may not be able to determine that Well A, Well 1, and East-block well 1.1a refer to the same well. Further, in one embodiment, it is not necessary to know that Well A and East-block well 1.1a are not the same well because that relationship will be inferred, as described below.

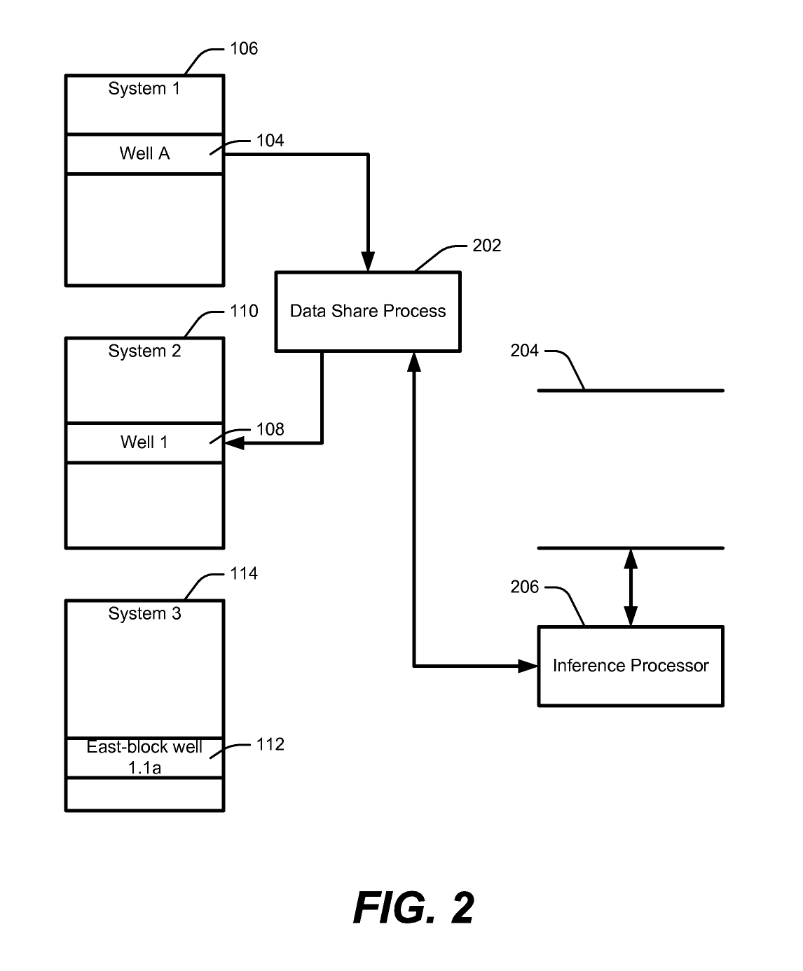

Similarly, in one embodiment, a data share process 202, illustrated in FIG. 2, is not able to determine that Well A, Well 1, and East-block well 1.1a are the same well. To assist with this determination, in one embodiment a relationship database 204 is established to store and manage the relationships between entities, such as Well A, Well 1, East-block well 1.1a, stored in other systems.

In one embodiment, illustrated in FIG. 2, the data share process 202 may be given the task of exporting data about Well A (i.e., some or all of data-1 104) from database-system-1 104 to database-system-2 110. This may happen, for example as the result of a change in the data-1 concerning Well A which triggers a defined workflow that requires the data produced by database-system-1 104 to be shared with database-system-2 110. In one embodiment, the data share process 202 is based on an industry standard such as the Wellsite Information Transfer Standard Markup Language (“WITSML”), OLE (object linking and embedding) for Process Control (“OPC”), Production Markup Language (“PRODML”), Reservoir Characterization Markup Language (“RESQML”), or other similar standards. In one embodiment, the data share process 202 sends a message to an inference processor 206 inquiring whether there is a relationship between the data-1 104 stored in database-system-1 106 and any data stored in database-system-2 110.

In one embodiment, the inference processor 206 queries the relationship database 204 and determines that a relationship between the data-1 104 stored in database-system-1 106 and data-2 108 stored in database-system-2 110 is stored in the relationship database 204. In a different embodiment, the inference processor 206 queries the relationship database 204 and determines that no such relationship has been stored in the relationship database 204.

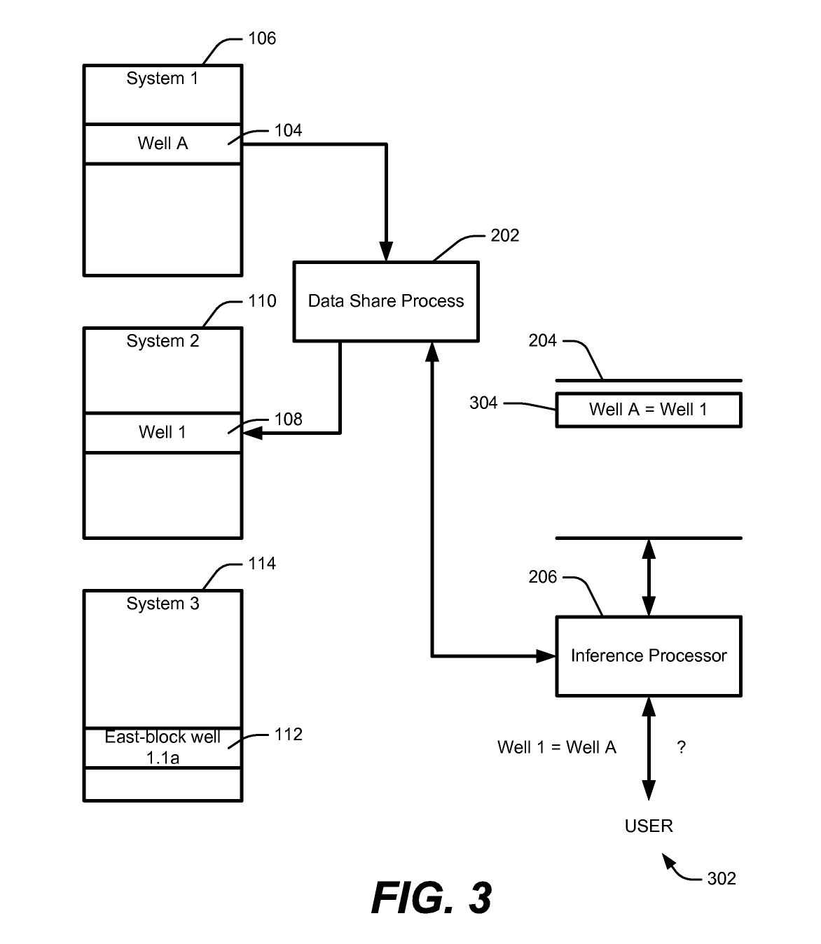

In one embodiment in which the relationship between data-1 104 and data-2 108 does not yet exist in the relationship database 204, shown in FIG. 3, the inference processor 206 prompts a user 302 (represented by the “?” in FIG. 3) inquiring whether there is a relationship between the data-1 104 stored in database-system-1 106 and any data stored in database-system-2 110. In one embodiment, the user 302 responds (represented by the “Well 1=Well A” in FIG. 3) that Well 1 in database-system-2 110 is the same as Well A in database-system-1 106. In one embodiment, the inference processor 206 responds to the data share process 202 with the relationship between Well 1 and Well A. In one embodiment, the inference processor 206 stores the relationship between Well 1 and Well A in a record 304 in the relationship database 204.

In one embodiment, the interaction with the relationship database 204 and the user described in the preceding paragraph is done by the data share process 202 rather than the inference processor 206.

In either case, in one embodiment, the relationship between data-1 102 concerning Well A in database-system-1 106 and data-2 108 concerning Well 1 in database-system-2 110 is stored in the relationship database 204. In one embodiment, the data share process 202 can now move some or all of data-1 104 from database-system-1 106 to database-system-2 110 and store it with data-2 108 in database-system-2 110.

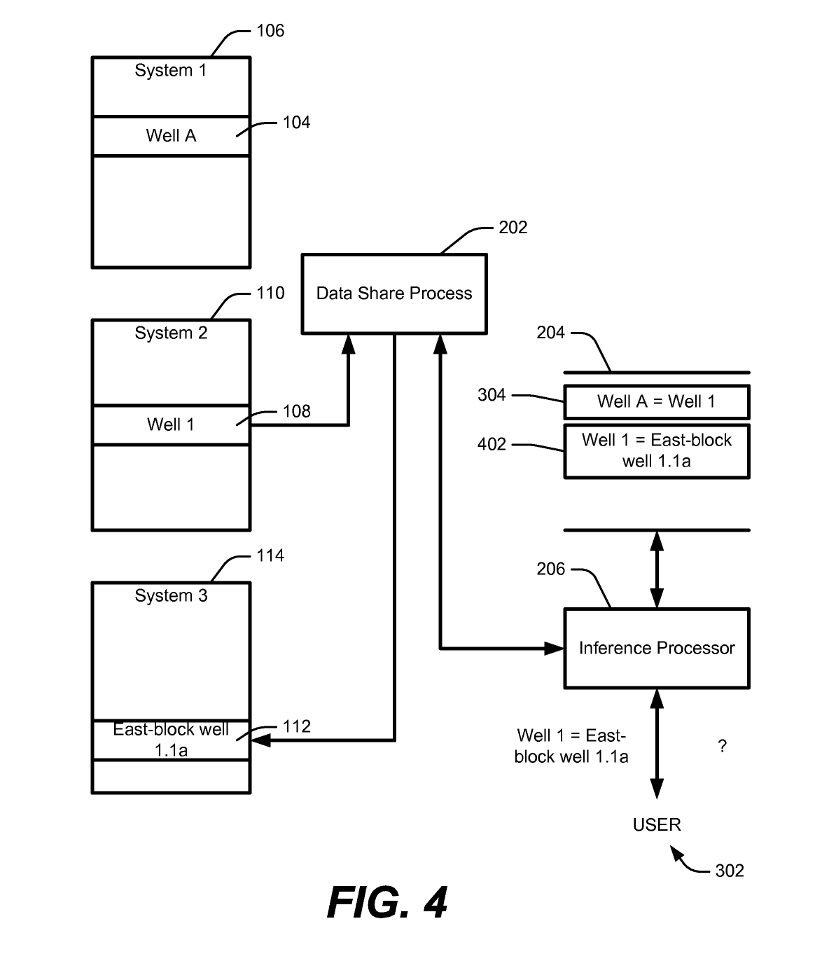

In one embodiment, illustrated in FIG. 4, the data share process 202 may be given the task of exporting data about Well 1 (i.e., some or all of data-2 108) from database-system-2 110 to database-system-3 114. In one embodiment, the data share process 202 sends a message to the inference processor 206 inquiring whether there is a relationship between the data-2 108 stored in database-system-2 110 and any data stored in database-system-3 114.

In one embodiment, the inference processor 206 queries the relationship database 204 and determines that a relationship between the data-2 108 stored in database-system-2 110 and data-3 112 stored in database-system-3 114 has been stored in the relationship database 204. In a different embodiment, the inference processor 206 queries the relationship database 204 and determines that no such relationship has been stored in the relationship database 204.

In one embodiment in which the relationship between data-2 108 and data-3 112 does not yet exist in the relationship database 204, the inference processor 206 prompts a user 302 (represented by the “?” in FIG. 4) inquiring whether there is a relationship between the data-2 108 stored in database-system-2 110 and any data stored in database-system-3 114. In one embodiment, the user 302 responds (represented by the “Well 1=East-block well 1.1 a” in FIG. 4) that Well 1 in database-system-2 110 is the same as East-block well 1.1a in database-system-3 114. In one embodiment, the inference processor 206 responds to the data share process 202 with the relationship between Well 1 and East-block well 1.1a. In one embodiment, the inference processor 206 stores the relationship between Well 1 and East-block well 1.1a in a record 402 in the relationship database 204.

In one embodiment, the interaction with the relationship database 204 and the user is done by the data share process 202 rather than the inference processor 206.

In either case, in one embodiment, the relationship between the data-2 108 concerning Well 1 in database-system-2 110 and the data-3 112 concerning East-block well 1.1a is stored in the relationship database 204. In one embodiment, the data share process 202 can now move some or all of data-2 108 from database-system-2 110 to database-system-3 114 and store it with data-3 112 in database-system-3 114.

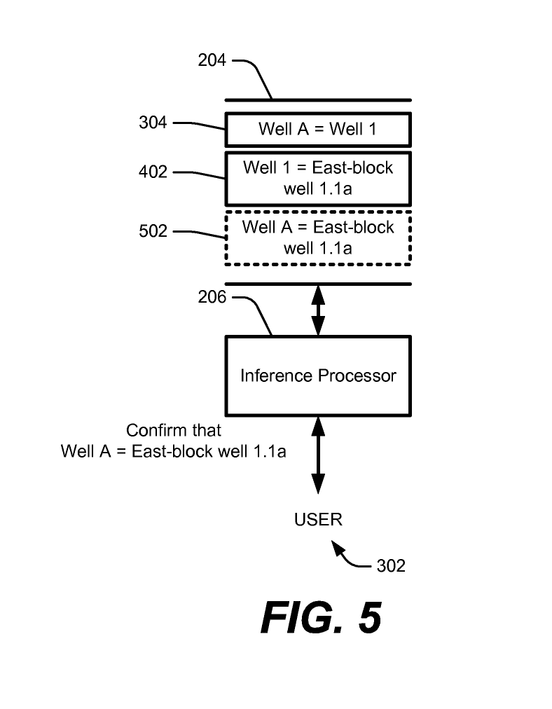

In one embodiment, illustrated in FIG. 5, the inference processor 206 processes the records in the relationship database 204. In particular, in one embodiment, the inference processor discovers the following relationships:

Well A=Well 1 (from record 304)

Well 1=East-block well 1.1a (from record 402).

The inference processor 206 applies the algebraic transitive property (i.e., if A=B and B=C, then A=C) to arrive at the following inferred relationship:

Well A=East-block well 1.1a (inferred).

The inference processor 206 stores the inferred relationship between Well A and East-block well 1.1a in record 502 in the relationship database 204.

In one embodiment, the inference processor 206 optionally prompts the user 302 (represented by “Confirm that Well A=East-block well 1.1a” in FIG. 5) and waits for a positive response before saving record 502.

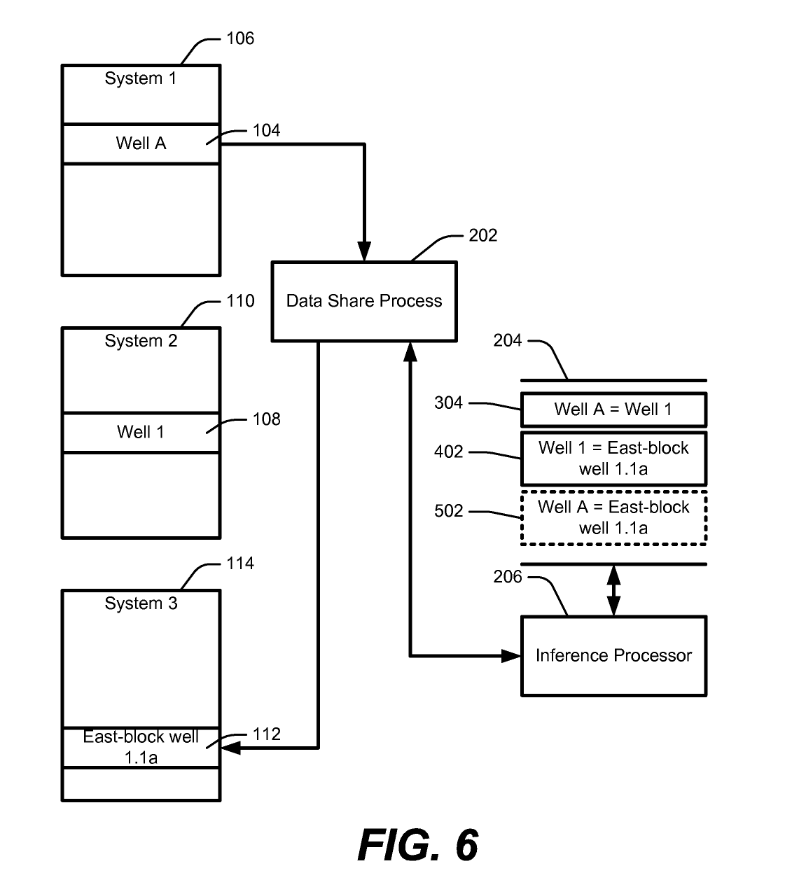

In one embodiment, illustrated in FIG. 6, the data share process 202 may be given the task of exporting data about Well A (i.e., some or all of data-1 104) from database-system-1 106 to database-system-3 114. In one embodiment, the data share process 202 sends a message to the inference processor 206 inquiring whether there is a relationship between the data-1 104 stored in database-system-1 106 and any data stored in database-system-3 114.

In one embodiment, the inference processor 206 queries the relationship database 204 and finds record 502 which indicates that Well A=East-block well 1.1a and that there is a relationship between the data-1 104 stored in database-system-1 106 and any the data-3 112 stored in database-system-3 114. In one embodiment, the inference processor optionally prompts the user 302 with the relationship information and waits for a positive response before responding with the relationship to the data share process 202.

In one embodiment, the interaction with the relationship database 204 and the user described in the preceding paragraph is done by the data share process 202 rather than the inference processor 206. In one embodiment, the data share process 202 can now move data-1 104 from database-system-1 106 to database-system-3 114 and store it with data-3 112 in database-system-3 114.

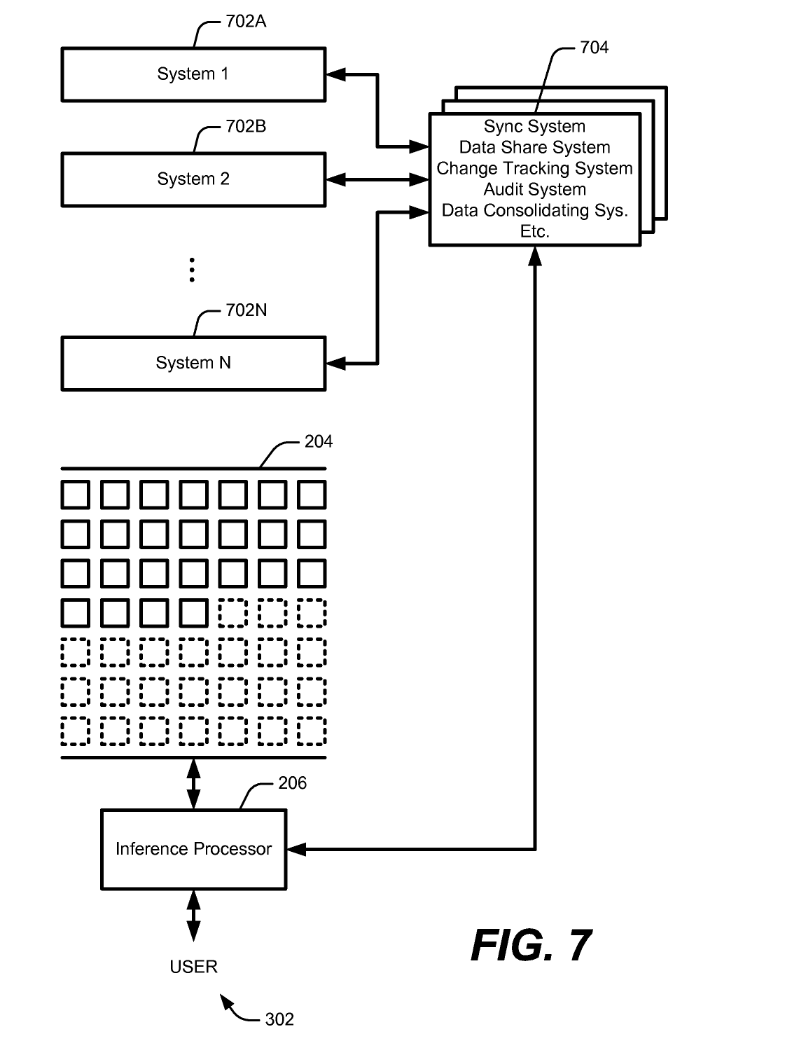

In one embodiment of a general system, illustrated in FIG. 7, a plurality of systems 702A, 702B, . . . , 702N that have data similar to that described above with respect to database-system-1 106, database-system-2 110, and database-system-3 114, that have data about the same entities, such as oil well 102, without relationships being recorded between the related data sets. In one embodiment, a variety of applications 704 access the data in the plurality of systems 702A, 702B, . . . , 702N. In one embodiment, one of the applications 704 is a synchronization system that synchronizes data among the plurality of systems 702A, 702B, . . . , 702N. In one embodiment, one of the applications 704 is a data share system that shares data between the systems 702A, 702B, . . . , 702N, similar to the data share process 202 described above with respect to FIGS. 2-6. In one embodiment, one of the applications 704 is a change tracking system that tracks changes to the data stored in systems 702A, 702B, . . . , 702N. In one embodiment, one of the applications is an audit system that tracks, and provides audits of, changes made in the relationship database 204. In one embodiment, one of the applications is a data consolidating system that consolidates data about the same entity from two or more of the systems 702A, 702B, . . . , 702N into a consolidated database (not shown).

In one embodiment, one or more of the applications 704 could make use of the type of relationship information collected and inferred as discussed above with respect to FIGS. 2-6. In one embodiment, the inference processor 206 interacts with the applications 704 and the user 302 as described above with respect to FIGS. 2-6, to create and maintain the relationship database 204.

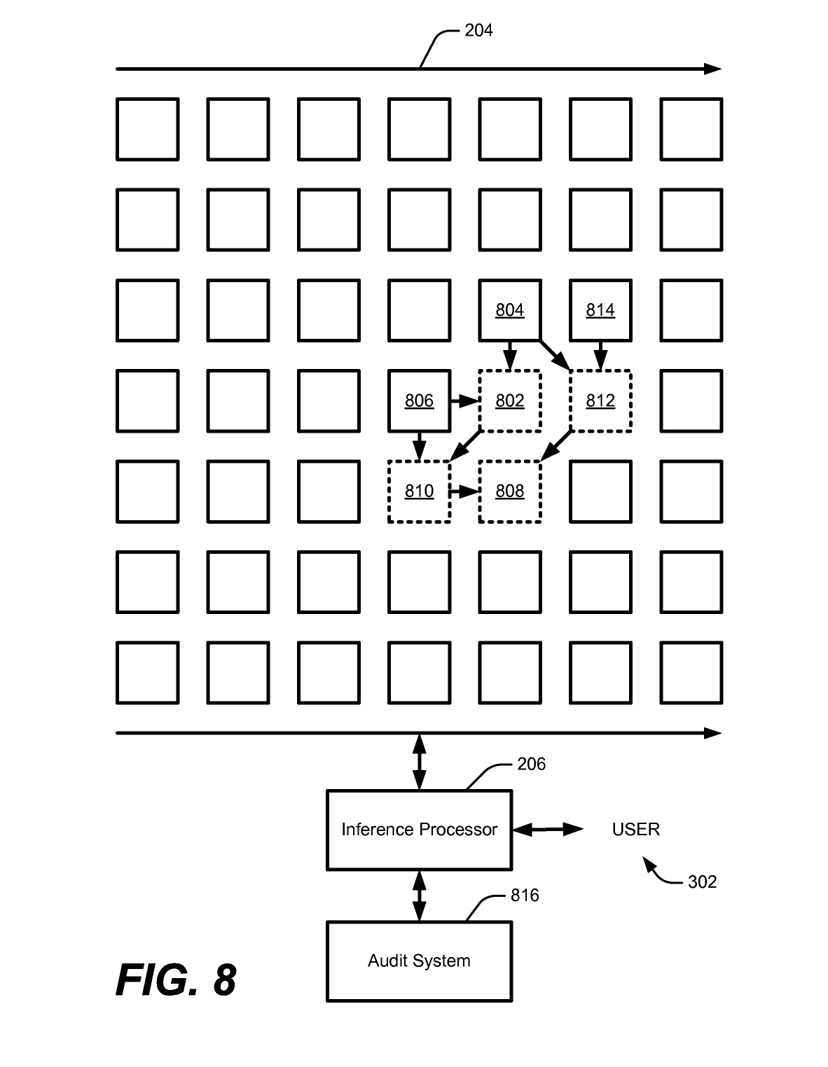

In one embodiment, the relationship database 204 contains confirmed relationship records, indicated by the squares with solid borders in the relationship database in FIG. 7, which have been confirmed by the user 302. For example, records 304 and 402 shown in FIGS. 3-6, which were created using a relationship provided by the user, would be considered confirmed relationship records, and would have solid borders in FIGS. 7 and 8.

In one embodiment, the relationship database 204 contains inferred relationship records, indicated by the squares with dashed borders in the relationship database in FIGS. 7 and 8, which have been inferred by the inference processor 206. For example, record 502 shown in FIGS. 5 and 6 was inferred by the inference processor 206, would be considered an inferred relationship record, and would have a dashed border in FIGS. 7 and 8.

In one embodiment, an inferred relationship record is transformed into a confirmed relationship record upon confirmation by the user 302, such as, for example, the interaction (“Confirm that Well A=East-block well 1.1a”) shown in FIG. 5.

In one embodiment, the inference processor 206 provides the user 302 with an interface through which the user 302 can review and confirm or reject the inferred relationship records.

In one embodiment, illustrated in FIG. 8, the relationship database 204 records the pedigree of inferred relationships. For example, in one embodiment, inferred relationship record 802 is shown as being inferred from confirmed relationship records 804 and 806, as indicated by the arrows between the squares representing those records in FIG. 8. Inferred relationship record 808 is shown as being inferred from inferred relationship records 810, and 812. Inferred relationship record 810 is shown as being inferred from inferred relationship record 802 and confirmed relationship record 806. Inferred relationship record 812 is shown as being inferred from confirmed relationship records 804 and 814.

In one embodiment, an audit system 816 is capable of discovering and managing the pedigrees of the inferred relationships in the relationship database 204. In one embodiment, the audit system 816 accesses the relationship database 204 through the inference processor 206. In one embodiment, the audit system 816 directly accesses the relationship database 204.

In one embodiment, the inference processor 206 or the audit system 816 tracks problems in the relationship database 204. For example, suppose that the user 302 rejects the inference reflected in inferred relationship record 802. That rejection would call into question the inferences that derive from inferred relationship record 802, including inferred relationship record 810. Further, because inferred relationship record 810 has been brought into question, inferred relationship record 808, which is partially inferred from inferred relationship record 810, is also brought into question. In one embodiment, the inference processor resolves these questions by querying the user 302.

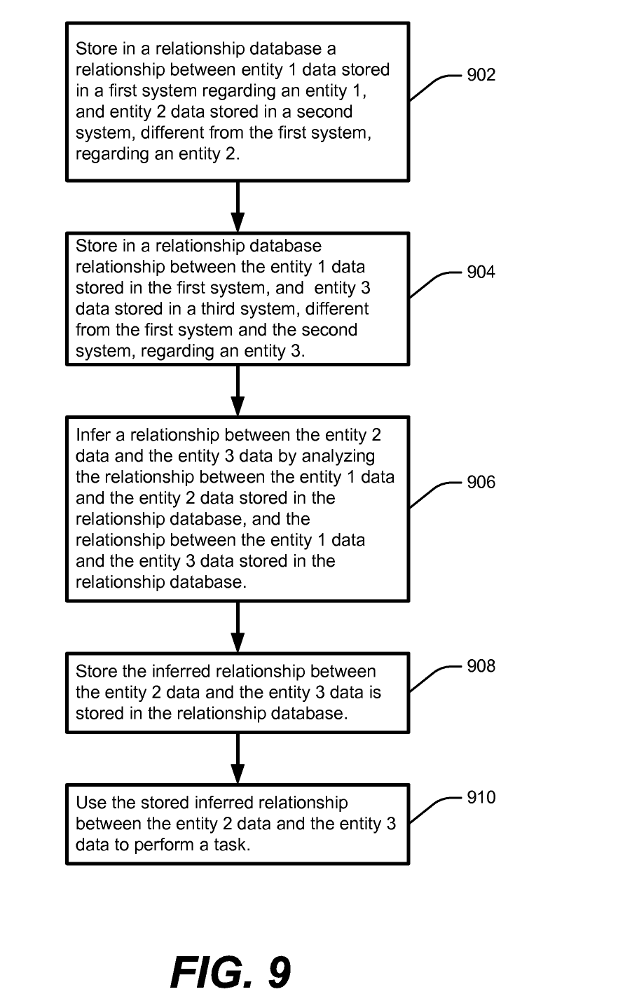

In use, in one embodiment, as shown in FIG. 9, a relationship between entity 1 data stored in a first system regarding an entity 1, and entity 2 data stored in a second system, different from the first system, regarding an entity 2 is stored in the relationship database (block 902). This is illustrated, for example in FIGS. 3-6, by any of records 304, 402, and 502 in relationship database 204. Using record 304 as an example, entity 1 would be Well A, entity 1 data would be the data-1 104, the first system would be database-system-1 106, entity 2 would be Well 1, entity 2 data would be data-2 108, the second system would be database-system-2 110.

In one embodiment, a relationship between the entity 1 data stored in the first system and entity 3 data stored in a third system, different from the first system and the second system, regarding an entity 3 is stored in the relationship database (block 904). This is illustrated, for example in FIGS. 3-6, by any of records 304, 402, and 502 in relationship database 204. Using record 402 as an example, entity 1 would be Well A, entity 1 data would be the data-1 104, the first system would be database-system-1 106, entity 2 would be East-block well 1.1a, entity 2 data would be data-3 112, the second system would be database-system-3 114.

In one embodiment, a relationship between the entity 2 data and the entity 3 data is inferred by analyzing the relationship between the entity 1 data and the entity 2 data stored in the relationship database, and the relationship between the entity 1 data and the entity 3 data stored in the relationship database (block 906). This is illustrated, for example in FIGS. 5 and 6 by the creation of record 502, which is an inferred relationship between the data-1 104 regarding Well A and the data-3 112 regarding East-block well 1.1a inferred from the data-1/data-2 and data-2/data-3 relationships represented by records 304 and 402, respectively.

In one embodiment, the inferred relationship between the entity 2 data and the entity 3 data is stored in the relationship database (block 908). This is illustrated, for example, in FIGS. 5 and 6 by record 502 and in FIGS. 7 and 8 by the squares with dashed borders.

The stored inferred relationship between the entity 2 data and the entity 3 data is used to perform a task (block 910). This is illustrated in FIG. 2-6, where data regarding two entities which are shown to be the same entity (i.e., Well A, Well 1, and East-block well 1.1a are different designations for the same well 102) are consolidated. This is also illustrated in FIG. 7, which shows applications 704 that use information in the relationship database 204 to perform these tasks.

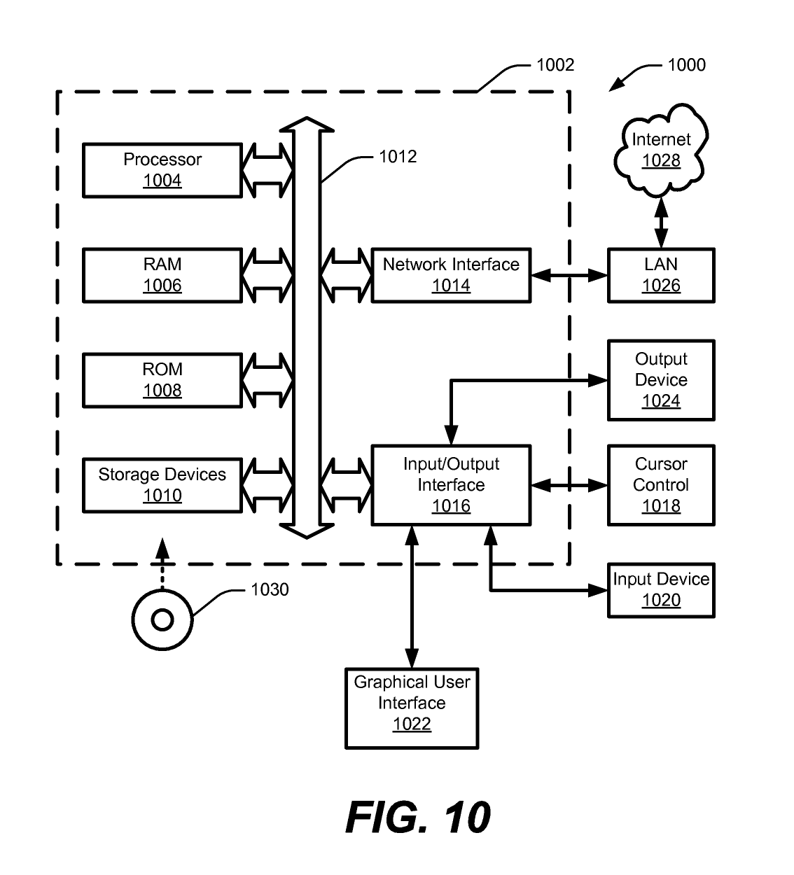

In one embodiment, a computer system environment 1000 for the inference processor 206 and relationship database 204, illustrated in FIG. 10, includes a computer housing 1002 that contains a processor 1004, such as a microprocessor; a random access memory 1006 (“RAM”); a read only memory 1008 (“ROM”); one or more storage devices 1010, such as hard drives, optical drives, solid state drives, and other similar devices; interconnected by a bus 1012. In one embodiment, one or more network interfaces 1014 and one or more input/output (“I/O”) interfaces 1016 provide external interfaces for the processor 1004 through the bus 1012. In one embodiment, one or more cursor control devices 1018, such as a mouse, a track pad, a graphics tablet, or the like, interface with the processor 1004 through the I/O interface 1016 and allow a user to manipulate a cursor. In one embodiment, one or more input devices 1020, such as a keyboard, a keypad, or the like, interface with the processor 1004 through the I/O interface 1016 and allow the user to input characters, numbers, drawings, and the like. In one embodiment, one or more graphical user interfaces 1022 interfaces with the processor 1004 through the I/O interface 1016 and allows the processor 1004 to display text, graphics, and other information. In one embodiment, one or more output devices 1024, such as printers, plotters, or the like, interface with the processor 1004 through the I/O interface 1016 and, for example, allow the production of hard copy output.

In one embodiment, the processor 1004 interfaces with a local area network (“LAN”) 126 through the network interface 1014. In one embodiment, the processor 104 can communicate with other computers through the LAN 1026. In one embodiment, the processor has access to the Internet 1028 through the LAN 1026.

In one embodiment, a computer program to implement the techniques described herein is stored on a non-transitory computer readable medium 1030, such as a compact disk (“CD”), a digital versatile disc or digital video disc (“DVD”), an external solid state drive, or the like. In one embodiment, the medium 1030 is loaded into a storage device 1010, such as an optical drive, and the computer program is read from the medium and stored in the RAM 1006, the ROM 1008, or another storage device 1010, such as a hard drive. In one embodiment, the computer program is compiled and linked, if necessary, and further prepared for execution. In one embodiment, and executable image of the computer program is stored in the RAM 1006, the ROM 1008, or another storage device 1010, such as a hard drive. In one embodiment, the processor 1004 executes the executable image, receive inputs from the cursor control device 1018 and input device 1020, stores data in the RAM 1006 and/or ROM 1008, and produce outputs on the graphical user interface 1022 and the output device 1024.

In one embodiment, the inference processor 206 and the relationship database 204 provide users with a way to manage data about their assets, thereby providing a technique to manage the actual assets. Using the example of oil well 102, the recognition that Well A, Well 1, and East-block well 1.1a are all the same entity or asset allows a user to use all of the data about oil well 102 to make decisions about its maintenance. In addition, the same data can be used to make decisions about drilling wells near oil well 102 or in the same type of environment as oil well 102.

Further, users can use these same techniques to manage other assets, such as real estate, capital improvements, and other assets in which data may be found in a variety of systems.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method, comprising:
storing in a relationship database a relationship between:
entity 1 data stored in a first system regarding an entity 1, and
entity 2 data stored in a second system, different from the first system, regarding an entity 2;
storing in the relationship database a relationship between:
the entity 1 data stored in the first system, and
entity 3 data stored in a third system, different from the first system and the second system, regarding an entity 3;
inferring a relationship between the entity 2 data and the entity 3 data by analyzing:
the relationship between the entity 1 data and the entity 2 data stored in the relationship database, and
the relationship between the entity 1 data and the entity 3 data stored in the relationship database;
storing the inferred relationship between the entity 2 data and the entity 3 data in the relationship database; and
using the stored inferred relationship between the entity 2 data and the entity 3 data to perform a task.

2. The method of claim 1 wherein using the stored inferred relationship between the entity 2 data and the entity 3 data to perform a task comprises:
moving a portion of the entity 2 data from the second system and consolidating it with the entity 3 data in the third system.

3. The method of claim 1 wherein:
storing in the relationship database the relationship between the entity 1 data stored in the first system and the entity 2 data stored in the second system comprises:
storing in the relationship database that the entity 1 and the entity 2 are the same;
storing in the relationship database the relationship between the entity 1 data stored in the first system and the entity 3 data stored in the third system comprises:
storing in the relationship database that the entity 1 and the entity 3 are the same;
inferring a relationship between the entity 2 data and the entity 3 data comprises:
using the transitive property to determine that the entity 1 and the entity 2 are the same.

4. The method of claim 1 wherein:
storing in the relationship database the relationship between the entity 1 data stored in the first system and the entity 2 data stored in the second system comprises:
receiving from a user the relationship between the entity 1 data stored in the first system and the entity 2 data stored in the second system.

5. The method of claim 1 further comprising:
inferring the relationship between the entity 1 data stored in the first system and the entity 2 data stored in the second system.

6. The method of claim 1 further comprising:
requesting confirmation from a user before storing the inferred relationship.

7. The method of claim 1 further comprising:
storing in an audit record in the relationship database that the relationship between the entity 2 data and the entity 3 data was derived from:
the relationship between the entity 1 data and the entity 2 data, and
the relationship between the entity 1 data and the entity 3 data.

8. A computer program stored in a non-transitory tangible computer readable storage medium, the program comprising executable instructions that cause a computer to:
store in a relationship database a relationship between:
entity 1 data stored in a first system regarding an entity 1, and
entity 2 data stored in a second system, different from the first system, regarding an entity 2;
store in the relationship database a relationship between:
the entity 1 data stored in the first system, and
entity 3 data stored in a third system, different from the first system and the second system, regarding an entity 3;
infer a relationship between the entity 2 data and the entity 3 data by analyzing:
the relationship between the entity 1 data and the entity 2 data stored in the relationship database, and
the relationship between the entity 1 data and the entity 3 data stored in the relationship database;
store the inferred relationship between the entity 2 data and the entity 3 data in the relationship database; and
use the stored inferred relationship between the entity 2 data and the entity 3 data to perform a task.

9. The computer program of claim 8 wherein, when using the stored inferred relationship between the entity 2 data and the entity 3 data to perform a task, the computer:
moves a portion of the entity 2 data from the second system and consolidating it with the entity 3 data in the third system.

10. The computer program of claim 8 wherein:
when storing in the relationship database the relationship between the entity 1 data stored in the first system and the entity 2 data stored in the second system, the computer:
stores in the relationship database that the entity 1 and the entity 2 are the same;
when storing in the relationship database the relationship between the entity 1 data stored in the first system and the entity 3 data stored in the third system, the computer:
stores in the relationship database that the entity 1 and the entity 3 are the same;
when inferring a relationship between the entity 2 data and the entity 3 data, the computer:
uses the transitive property to determine that the entity 1 and the entity 2 are the same.

11. The computer program of claim 8 wherein:
when storing in the relationship database the relationship between the entity 1 data stored in the first system and the entity 2 data stored in the second system, the computer:
receives from a user the relationship between the entity 1 data stored in the first system and the entity 2 data stored in the second system.

12. The computer program of claim 8 wherein the program further comprises executable instructions that cause a computer to:
inferring the relationship between the entity 1 data stored in the first system and the entity 2 data stored in the second system.

13. The computer program of claim 8 wherein the program further comprises executable instructions that cause a computer to:
request confirmation from a user before storing the inferred relationship.

14. The computer program of claim 8 wherein the program further comprises executable instructions that cause a computer to:
store in an audit record in the relationship database that the relationship between the entity 2 data and the entity 3 data was derived from:
the relationship between the entity 1 data and the entity 2 data, and
the relationship between the entity 1 data and the entity 3 data.

15. A system comprising:
a relationship database stored on a storage device, the relationship database comprising:
an entity1-entity2 relationship record indicating an entity1-entity2 relationship between:
entity 1 data stored in a first system regarding an entity 1, and
entity 2 data stored in a second system, different from the first system, regarding an entity 2;
an entity1-entity3 relationship record indicating an entity1-entity3 relationship between:
the entity 1 data stored in the first system, and
entity 3 data stored in a third system, different from the first system and the second system, regarding an entity 3;
an entity2-entity3 relationship record indicating an entity2-entity3 relationship between the entity 2 data and the entity 3 data;
a computer input device whereby:
the entity1-entity2 relationship was input to the relationship database; and
an inference processor whereby:
the entity2-entity3 relationship was inferred based on the entity1-entity2 relationship and the entity1-entity3 relationship.

16. The system of claim 15 wherein the relationship database further comprises:
an audit record including an indication that the relationship between the entity 2 data and the entity 3 data was derived from the entity1-entity2 relationship and the entity1-entity3 relationship.

17. The system of claim 15 wherein:
the entity1-entity2 relationship record includes an indication that the entity1-entity2 relationship was input to the relationship database through a computer input device;
the entity1-entity2 relationship record includes an indication that the entity1-entity2 relationship was input to the relationship database through a computer input device; and
the entity1-entity3 relationship record includes an indication that the entity1-entity3 relationship was inferred.

18. The system of claim 15 wherein:
the inference processor inferred the entity1-entity3 relationship.

19. The system of claim 15 wherein:
the inference processor inferred the entity1-entity3 relationship using the transitive property.

20. The system of claim 15 wherein:
the inference processor requested confirmation from a user through a computer output device before storing the entity2-entity3 relationship record in the relationship database.
